(19) United States
(12) Patent Application Publication
(10) Pub. No.: US 2012/0247564 A1
(43) Pub. Date: Oct. 4, 2012

(54) SHOCKLESS SLIT VALVE CONTROL

(76) Inventor: JEFFREY A. KHO, (US)

(21) Appl. No.: 13/076,398

(22) Filed: Mar. 30, 2011

(51) Int. Cl. F16K 1/00

(52) U.S. Cl. 137/1; 251/318

(57) ABSTRACT

Embodiments disclosed herein generally relate to methods for sealing a processing chamber with a slit valve door. The slit valve door rises from a position below the substrate transfer port for the processing chamber to a raised position. The slit valve door then expands until an o-ring on the door seals against the sealing surface. The slit valve door rises by flowing clean dry air into a vertical air cylinder coupled to the slit valve door. By controlling the rate of air flow venting from the air cylinder using high and low conductance exhaust lines, the speed with which the slit valve door ascends or descends is controlled to ensure that the door gently moves between positions. Thus, the slit valve door may be prevented from moving into position with too great a force that may jolt or shake the processing chamber and produce undesired particles that may contaminate the process.

### BACKGROUND

1. Field

Embodiments of the present invention generally relate to a slit valve door and a method for sealing a chamber with a slit valve door.

2. Description of the Related Art

In semiconductor, flat panel display, photovoltaic/solar panel, and other substrate processing systems, it is common to arrange vacuum chambers (i.e., load locks, transfer chambers, process chambers) in a cluster, in-line, or a combination of cluster/in-line arrangements to process substrates. These systems may process substrates in single or batch substrate fashion. During processing, substrates may be transferred to and from chambers in which vacuum must be maintained or established. To allow access to the inside of the chamber, and to enable vacuum operation, a substrate transfer port formed through the chamber wall in the shape of a slit is frequently provided to accommodate the substrate being processed. The substrate transfer port is opened and closed (e.g., sealed) by a slit valve assembly.

The slit valve assembly includes a slit valve door that may be movably actuated to open or close the substrate transfer port. When the slit valve door is clear of the substrate transfer port, one or more substrates may be transferred between the two vacuum chambers through the substrate transfer port. When the slit valve port is closed and sealed by the slit valve door, substrates may not be transferred in or out of vacuum chambers through the substrate transfer port and the vacuum chambers remain sealed. For example, two vacuum chambers connected by a slit valve assembly may include a process or transfer chamber which requires periodic isolation from a load lock chamber in order to maintain vacuum in the process or transfer chamber when the load lock chamber is vented.

Generally, the operation speed of the slit valve door is important to the throughput of substrate processing system. However, faster door operations result in large shocks or vibrations as the slit valve door opens and closes. The shocks may loosen and disperse particles within the vacuum chambers, which may create defects on the substrate. Additionally, large shocks over time may loosen fasteners and increase wear on the components of the slit valve door.

Therefore, there is a need for a slit valve door capable of sealing chambers with improved mechanical motion.

### SUMMARY

Embodiments disclosed herein generally relate to method and apparatus for sealing a processing chamber with a slit valve door. In one embodiment, a slit valve assembly includes a housing having a substrate transfer port formed in sidewalls of the housing. A slit valve door is disposed within an interior volume of the housing. The slit valve door is coupled to an actuator, which is operable to move the slit valve door between an open position and a closed position within the housing. The slit valve assembly is further coupled to a flow control circuit having an air supply flow path, a high conductance vent flow path, and a low conductance vent flow path selectively coupled to the actuator.

In one embodiment, a method of sealing a chamber coupled to a slit valve assembly is disclosed. The method includes actuating a slit valve door at a first speed for a first period of time from a first position towards a second position. The slit valve assembly body may have passages formed through walls of the body. The method further includes detecting when the slit valve door nears the second position and, in response to the detecting, actuating the slit valve door at a second speed for a second period of time such that the second speed is less than the first speed.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic sectional view of two chambers connected by a slit valve assembly.

FIG. 2 is a sectional view of one embodiment of the slit valve assembly of FIG. 1 having a flow control circuit.

FIG. 3 is a sectional view of the slit valve assembly of FIG. 2 having a sealed slit valve door.

FIG. 4 is a sectional view of the slit valve assembly of FIG. 2 having a slit valve door in a lowered position.

FIG. 5 is a schematic view of one embodiment of the flow control circuit of FIG. 2.

FIG. 6 is a flow diagram of a method for closing the slit valve assembly of FIG. 2 according to embodiments of the invention.

FIG. 7 is a flow diagram of a method for opening the slit valve assembly of FIG. 2 according to embodiments of the invention.

FIGS. 8A and 8B are graphs illustrating position and shock forces during operation of a slit valve door according to one embodiment of the invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention generally relate to an apparatus and methods for sealing a vacuum chamber with a slit valve assembly. The slit valve assembly utilizes high and low conductance pneumatic cylinder exhaust lines to control acceleration and deceleration of components to prevent jolting or shaking of the vacuum chamber which may produce undesired particles and process contamination. Embodiments of the invention will be described below in regards to a slit valve assembly and chambers available from AKT America, Inc., a subsidiary of Applied Materials, Inc., Santa Clara, Calif. However, it is to be understood that the invention has utility using other slit valve assemblies and other chambers, including those sold by other manufacturers.

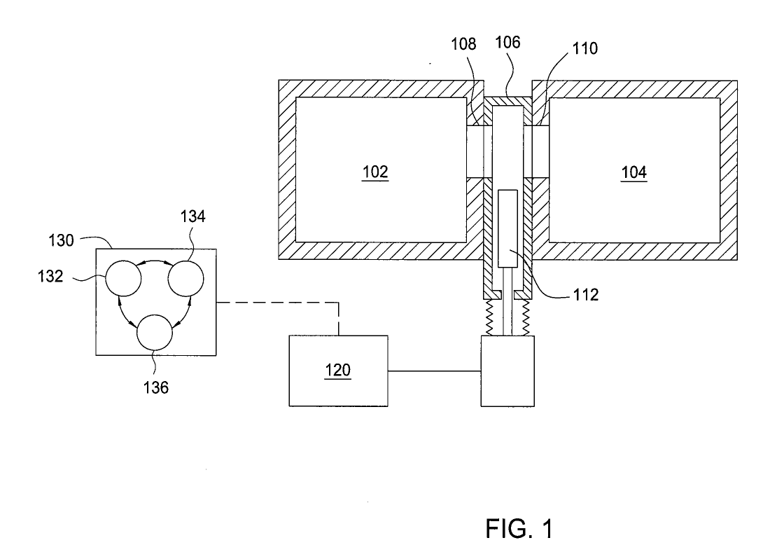

FIG. 1 is a schematic sectional view of two chambers 102, 104 coupled by a slit valve assembly 106. The vacuum chambers 102, 104 have substrate transfer ports 108, 110 formed therethrough that permit a substrate to enter and exit the chamber 102, 104. The slit valve assembly 106 is operable to seal the vacuum chambers 102, 104 so that the vacuum chambers 102, 104 are environmentally isolated from each other. The slit valve assembly 106 includes a door 112 that may be moved between positions that seal the substrate transfer ports 108, 110 and allow substrates to pass between the vacuum chambers 102, 104 through the substrate transfer ports 108, 110.

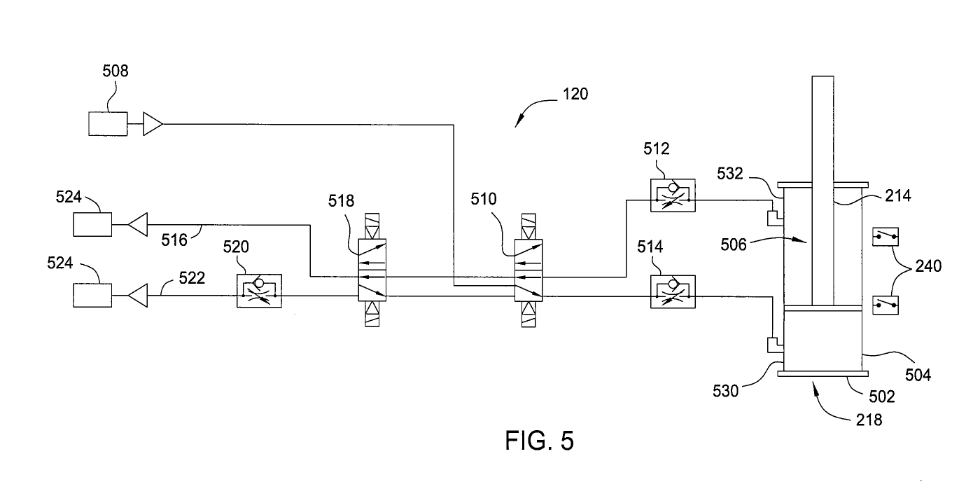

In one embodiment, a flow control circuit 120 is coupled to the various components of the slit valve assembly 106 to facilitate operation of the slit valve door 112. The flow control circuit 120 is further described in detail below with regards to FIG. 5. Additionally, a controller 130, including a central processing unit (CPU) 136, a memory 132, and support circuits 134 for the CPU 136, is coupled to the flow control circuit 120 and to various components of the slit valve assembly 106 to facilitate control of the slit valve door 112. To facilitate control of the valve assembly and control circuit as described above, the CPU 136 may be one of any form of general purpose computer processor that can be used in an industrial setting. The memory 132 is coupled to the CPU 136. The memory 132, or computer-readable medium, may be one or more of readily available memory such as random access memory (RAM), read only memory (ROM), floppy disk, hard disk, or any other form of digital storage, local or remote. The support circuits 134 are coupled to the CPU 136 for supporting the processor in a conventional manner. These circuits include cache, power supplies, clock circuits, input/output circuitry and subsystems, and the like. A method for controlling the operation of the door, such as described herein, is generally stored in the memory 132 as a software routine. The software routine may also be stored and/or executed by a second CPU (not shown) that is remotely located from the hardware being controlled by the CPU 136.

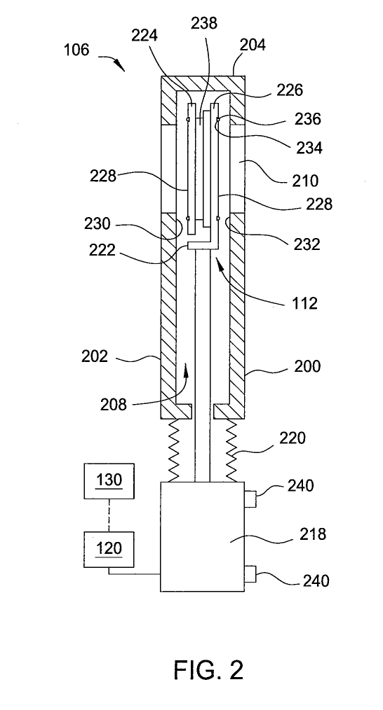

FIGS. 2-4 are sectional front views of one embodiment of a slit valve assembly 106. The slit valve assembly 106 generally includes a housing 200 having a top 204, a bottom 206, and side walls 202 that define an interior volume 208 within the housing 200. Passages 210 are formed through the side walls 202 to align with the substrate transfer ports 108, 110 seen in FIG. 1. In one embodiment, the passages 210 are sized to permit substrates to pass through the slit valve assembly 106.

The slit valve assembly 106 further includes a slit valve door 112 disposed within the interior volume 208 of the housing 200. The slit valve door 112 includes a first seal plate 224 and a second seal plate 226 coupled to a base 222. The first and second seal plates 224, 226 are coupled to a seal plate actuator 238, which is configured to urge the first and second plates 224, 226 towards the sidewalls 202. The seal plates 224, 226, each have a sealing face 228 configured to seal against inside surfaces 230, 232 of the side walls 202. The seal plates 224, 226 include o-ring glands 234 which accommodates o-rings 236. The o-rings 236 provide a seal between the sealing faces 228 and the side walls 202.

The slit valve door 112 is coupled to a door actuator 218 by a rod 214 extending through a hole 216 formed through the bottom 206 of the housing 200. The door actuator 218 may be an air cylinder or a pneumatic cylinder. In the embodiment shown in FIG. 2, the door actuator 218 is a vertically-oriented, double-acting air cylinder. A seal 220 may optionally be disposed around the hole 216 to form a seal between the bottom 206 of the housing 200 and the door actuator 218.

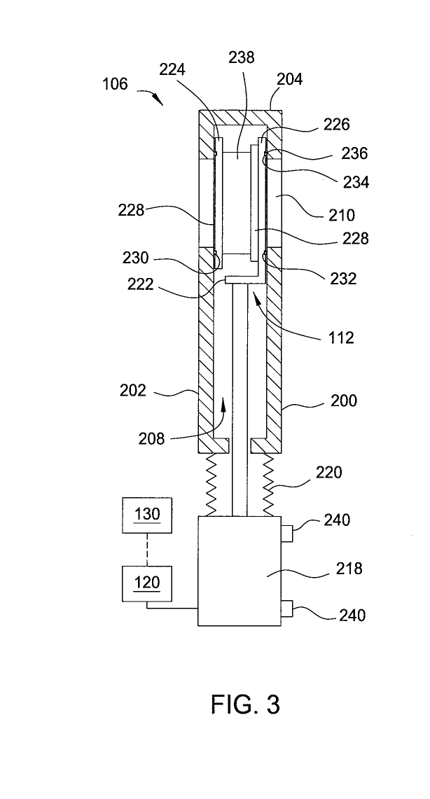

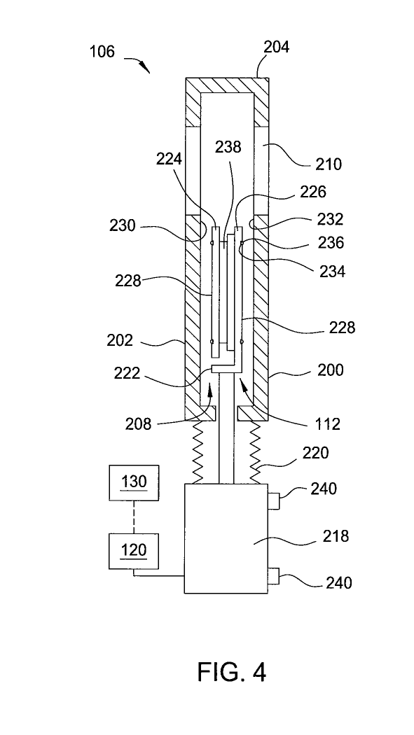

The door actuator 218 is configured to move the slit valve door 112 to move between a lowered position and a raised position within the interior volume 208 of the housing 200. In the raised position, as seen in FIG. 2, the slit valve door 112 is arranged within the interior volume 208 such that the first and second seal plates 224, 226 are aligned with the passages 210. In the lowered position, as seen in FIG. 4, the slit valve door 112 is disposed proximate the bottom of the interior volume 208 of the housing 200 with the seal plates 224, 226 clear of the passages 210, such that a substrate may pass through the slit valve assembly 106 through the passages 210. As shown in FIG. 3, the slit valve door 112 is also configured to seal the passages 210 when in the raised position by sealing the seal plates 224, 226 against the sidewalls 202.

The slit valve assembly 106 further includes sensors 240 coupled to the controller 130. The sensors 240 are configured to determine the position of the slit valve door 112 within the interior volume 208. In one embodiment, the sensors 240 may include flag sensors coupled to the slit valve assembly 106 at locations near the end stroke positions of the door actuator 218.

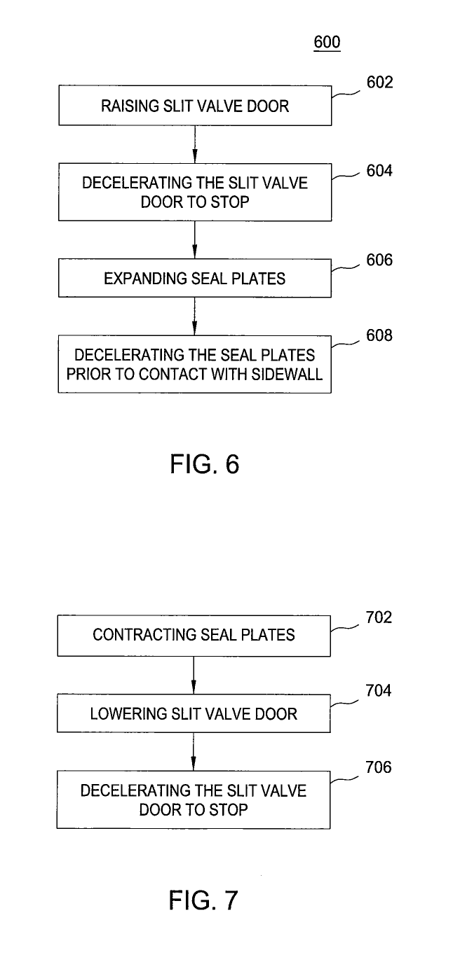

The flow control circuit 120 and the controller 130 are operated to control the slit valve door 112 and the door actuator 218 using a method as further described in FIG. 6. Generally, the flow control circuit 120 and controller 130 may use readings from the sensors 240 to determine when the acceleration and deceleration rate and speed of the slit valve door 112 should change so that the slit valve door 112 rapidly and smoothly moves between raised and lowered positions with reduced jolts and shocks. The controller 130 may further control the expansion of the slit valve door 112 such that the seal plates 224, 226 smoothly seal against the sidewalls 202 with reduced jolts and shocks.

FIG. 5 is a schematic diagram of one embodiment of a flow control circuit 120 coupled to a door actuator 218 to selectively raise and lower a slit valve door 112. As shown in FIG. 5, the door actuator 218 is double acting, vertical air cylinder 502 having a piston 504 disposed within an interior volume 506 of the air cylinder and coupled to a slit valve door by a rod 214. Sensors 240 are located at end positions of the air cylinder 502 to detect when the piston 504 moves proximate the ends of the door actuator's stroke positions.

A supply of clean, dry air (CDA) 508 is fluidly coupled to the air cylinder 502 by an air supply valve 510, a first flow control valve 512, and a second flow control valve 514 to selectively provide air to the air cylinder 502. In the embodiment shown, the air supply valve 510 includes a first state that selectively couples the CDA supply 508 to a top end 530 of the air cylinder and selectively couples a bottom end 532 of the air cylinder to vent exhaust. In one embodiment, the air supply valve 510 also includes a second state that selectively couples the CDA supply 508 to the bottom end 532 of the air cylinder and selectively couples the top end 530 of the air cylinder to vent exhaust. The air supply valve 510 may be a diverter valve, a spool valve, a directional control valve, pneumatic valve or a solenoid valve of other suitable valve. The first flow control valve 512 may control the flow rate of air into the top end 530 of the air cylinder 502 while providing a full flow rate out of the top end 530. Similarly, the second flow control valve 514 may control the flow rate of air into the bottom end 532 of the air cylinder 502 while providing a full flow rate out of the bottom end 532 of the air cylinder. Providing air to the bottom end causes the rod 214 to extend (raising the door 112) while providing air to the top and causes the rod 214 to retract (lowering the door 112). Controlling the conductance of the exhaust of the air cylinder 502 controls the acceleration and deceleration of the rod 214, and hence, the level shock caused by movement of the door 112.

The flow control circuit 120 further includes a high conductance exhaust line 516 and a low conductance exhaust line 522 fluidly coupled to the air cylinder 502 by a conductance switch 518 to permit air within the interior volume 506 of the air cylinder 502 to vent out to exhaust 524. The conductance switch 518 selectively couples the high conductance line 516 or the low conductance line 522 to the air cylinder 502 to change the flow rate of exhaust from air cylinder 502. In one embodiment, the conductance switch 518 may be a diverter valve, a spool valve, a directional control valve, pneumatic valve, a solenoid valve or other suitable valve. The flow control circuit 120 optionally includes a third flow control valve 520 disposed in the low conductance exhaust line 522. The third flow control valve 520 may control the flow rate through the low conductance exhaust line 522 to exhaust to further reduce the rate of exhaust from the air cylinder 502. The conductance of the high conductance exhaust line 516 is greater than the conductance of the low conductance exhaust line 522, for example, at least 80% greater. In one embodiment, the high conductance exhaust line 516 has a flow rate of greater than about 650 L/min to 700 L/min. In one embodiment, the low conductance exhaust line 522 has a flow rate of less than about 75 L/min.

FIG. 6 is a flow diagram of one embodiment of a method 600 for sealing the slit valve assembly described in FIGS. 2-4. It is understood that the method may be practiced utilizing other apparatuses, and it is also understood that the apparatus shown may be utilized with other methods for operating a slit valve assembly.

The method 600 begins at 602 by raising the slit valve door 112 into a raised position. To move the slit valve door 112 into a raised position, the flow control circuit 120 provides air to the bottom end of the air cylinder 502 of the door actuator 218 to extend the rod 214 and move the slit valve door 112 upwards within the interior volume 208 by a first distance for a first period of time.

In one embodiment, the air supply switch 510 and second flow control valve 514 are set to a state to fluidly couple the CDA supply 508 to the bottom end 532 of the air cylinder 502. Clean, dry air is then supplied to the bottom end 532 of the air cylinder 502. The air pressure from the air filling the interior volume 506 below the piston 504 from the bottom end 532 urges the piston 504 and rod 214 upwards, thereby elevating the slit valve door 112. Sufficient air is supplied to the air cylinder 502 to move the slit valve door 112 to the raised position proximate to the passages 210.

At the same time, air is vented from the top end 530 of the air cylinder 502. The first control valve 512 permits air to flow out of the top end 530 of the air cylinder 502 at a full flow rate as the piston 504 pushes the air above the piston 504 out of the air cylinder. The conductance switch 518 is set to a state that fluidly couples the air flowing out of the air cylinder 502 to the high conductance exhaust line 516. The use of the high conductance exhaust line 516 permits a rapid vent from the top of the air cylinder, thereby allowing the slit valve door 112 to accelerate quickly and move rapidly upwards.

The method 600 continues at 604 by decelerating the slit valve door 112 prior to reaching in the raised position. If the slit valve door 112 stops suddenly from a full speed at the raised position, the slit valve assembly 106 may be jolted, which may cause the creation of particles within the processing chambers that may contaminate the substrate within the chambers. According to one embodiment of the invention, as the slit valve door 112 approaches the raised position, the door actuator 218 decelerates the slit valve door 112 for a second period of time such that slit valve door 112 gently arrives in the raised position and smoothly stops. The door actuator 218 may increase the deceleration of the slit valve door 112 as the slit valve door 112 moves closer to the raised position.

The slit valve door 112 may be smoothly decelerated by reducing the flow rate of air venting from the door actuator 218. As the slit valve door 112 reaches the raised position. In one embodiment, the controller 130 determines when the slit valve door 112 has reached a predetermined position proximate to and spaced from the raised position by using the sensors 240 to detect when the piston 504 approaches the end stroke position at the top end 530 of the air cylinder. The controller 130 then activates the conductance switch 518 to change states as to switch the venting end of the air cylinder 502 from the high conductance exhaust line 516 to the low conductance exhaust line 522, thereby fluidly coupling the top end 530 of the air cylinder to vent exhaust 524 via the low conductance exhaust line 522. The reduced flow rate of the low conductance line 522 reduces the rate at which air can be vented from the air cylinder 502, thereby showing the motion of other rod 214 and decelerating the slit valve door 112. The third flow control valve 520 may be operated to further decrease the flow rate of the low conductance exhaust line 522 to fine-tune the deceleration of the slit valve door 112 at the end of the slit valve door's upward travel. In other embodiments, a flow restriction through the third control valve 520 is increased after actuating of the conductance switch 518 to decrease the conductance of the low conductance exhaust line 522 while air is venting therethrough.

The slit valve door 112 smoothly reaches the raised position at a decelerated speed such that the slit valve door 112 does not cause a substantial shock or jolt to the slit valve assembly 106. In one embodiment, the flow control circuit 120 reduces shock exerted on the slit valve assembly 106 by about 90 percent as compared to conventional single line vented systems. In another embodiment, the slit valve door 112 is decelerated by the flow control circuit 120 such that the slit valve door 112 coming to a stop in the raised position exerts a force of no more than 0.3 g's on the slit valve assembly 106. In one embodiment, the total time in which the slit valve door 112 takes to move 142 mm from the lowered position to the raised position is about 0.9 seconds.

After reaching the raised position, the slit valve door 112 may be operated to close the passages 210. At 606, the seal plates 224, 226 of the slit valve door 112 expand towards the sidewalls 202 during a third period of time. In one embodiment, a gas may be introduced into the seal plate actuator 238 by a second flow control circuit (not shown) to expand the seal plates 224, 226 for a distance just prior to the o-rings 236 initially contacting against the inside surfaces 230, 232 of the housing 200. Although not shown, the second flow circuit may be configured in one embodiment to be identical to the flow control circuit 120.

At 608, the seal plates 224, 226 are then decelerated for a fourth period of time prior to contact with the sidewalls 202. In one embodiment, the controller 130 may control the flow rate of gas entering the seal plate actuator 238 to control the rate of expansion of the slit valve door 112 and the speed at which the first and second seal plates 224, 226 contact the inside surfaces 230, 232. When the first and second seal plates 224, 226 near the inside surfaces 230, 232, the flow rate of gas may be reduced to decelerate the seal plates 224, 226 such that the o-rings 236 smoothly compress against the inside surfaces 230, 232.

FIG. 7 is a flow diagram of one embodiment of a method 700 for operating the slit valve assembly described in FIGS. 2-4 to open the slit valve door 112. The method 700 begins at 702 by contracting the seal plates 224, 226 from the sidewalls 202. In one embodiment, the gas introduced into the seal plate actuator 238 may be vented to atmosphere by the second flow control circuit. The gas may optionally be vented by a vacuum pump coupled to the slit valve door 112.

At 704, the slit valve door 112 is then lowered after the seal plates 224, 226 have been retracted clear of the side walls 202. The door actuator 218 retracts the rod 214 downwards to move the slit valve door 112 to a lowered position. In one embodiment, the air supply valve 510 is set to a first state to fluidly couple the CDA supply 508 to the top end 530 of the air cylinder 502 through the first flow control valve 512. The first state of the air supply valve 510 also fluidly couples the bottom end 532 of the air cylinder to vent exhaust. The conductance switch 518 is set to a state that fluidly couples the high conductance exhaust line 516 to the air cylinder 502.

Clean, dry air is supplied to a top end of the air cylinder 502. As air fills the interior volume 506 from the top of the air cylinder, the air pressure above the piston 504 urges the piston 504 and rod 214 downwards, thereby lowering the slit valve door 112. Sufficient air is supplied to the top end of the door actuator 218 to lower the slit valve door 112 to a positioned proximate the bottom of the interior volume 208. Air flows out of the bottom end 532 of the air cylinder to exhaust through the high conductance exhaust line 516. The high flow rate of the high conductance exhaust line 516 permits a rapid vent from the bottom of the air cylinder, thereby allowing the slit valve door to move quickly.

At 706, the slit valve door is then decelerated to smoothly stop at a lowered position. In one embodiment, the flow control circuit 120 reduces the flow rate of air venting from the air cylinder 502 to smoothly decelerate the slit valve door 112. When the sensors 240 detect that the piston 504 is approaching the end position at the bottom of the air cylinder 502, the conductance switch 518 is activated to change to a state that fluidly couples the interior volume of the air cylinder 502 to the low conductance exhaust line 522 from the high conductance exhaust line 516. The reduced flow rate of the low conductance exhaust line 522 reduces the cylinder speed and, consequently, the speed of the slit valve door 112. The third flow control valve 520 may be operated to further reduce the flow rate of the low conductance exhaust line 522 and smoothly decelerate the slit valve door 112 into the lowered position.

In one embodiment, the slit valve door 112 is decelerated by the flow control circuit 120 such that the slit valve door 112 coming to a stop in the lowered position exerts a force of no more than 0.4 g3 s on the slit valve assembly 106. In one embodiment, the total time in which the slit valve door 112 takes to move 142 mm from the raised position to the lowered position is about 0.8 seconds.

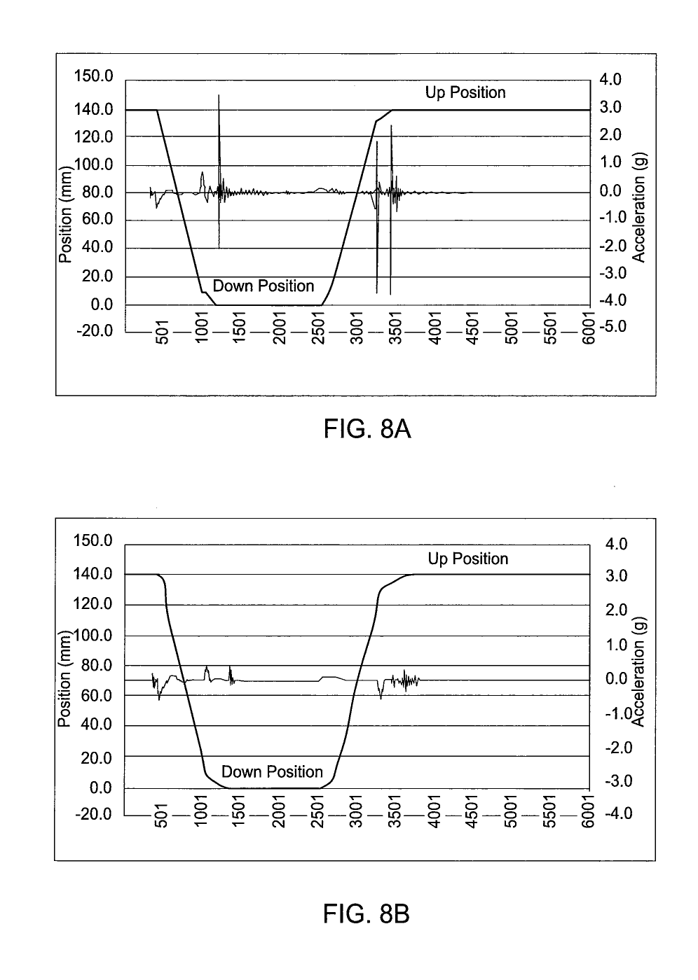

FIG. 8A is a graph showing positions and force values during operation of the slit valve door without use of the deceleration method and apparatus described above. When the slit valve door 112 is lowered to a down position at around time 1001, a corresponding spike in measured shock force as exerted on the slit valve assembly is measured. In some cases, the shock force in conventional systems can be as great as 3.5 g's of force. Similarly, a corresponding spike in measured shock force is measured when the slit valve door 112 stops at an up position at around time 3501. In some cases, the shock force in conventional systems felt by the slit valve assembly may reach 3.7 g's of force.

In contrast, FIG. 8B is a graph showing position and force values during operation of the slit valve door according to embodiments of the invention. When the slit valve door 112 is lowered to the down position, at around time 1001, the slit valve door is smoothly decelerated to stop at the down position with reduced force. As shown in FIG. 8B, the shock force of the slit valve door 112 measured upon reaching the down position is less than 0.4 g's of force. Similarly, when the slit valve door 112 is raised to an up position, at around time 3501, the slit valve door is smoothly decelerated to stop at the up position. As shown in FIG. 8B, the shock force measured when the slit valve door 112 reaches the up position is less than 0.3 g's of force.

Thus, by utilizing high conductance and low conductance exhaust lines, the slit valve assembly permits a first, fast motion of the slit valve door followed by a second, slower motion as the slit valve door approaches the end of travel. Embodiments of the invention advantageously reduce shocks or jolts during operation of the slit valve door, thereby reducing risk of contamination from particles shaken free during processing while advantageously maintaining fast opening and closing of the slit valve door. Additionally, embodiments of the invention advantageously permits improved operating times of the slit valve door without risking reliability on the mechanical components of the slit valve assembly. Further, the slit valve door assembly advantageously utilizes a single set of valves to control the speed of the vertical air cylinder in both upwards and downwards directions.

While the foregoing is directed to embodiments of the present invention, other and further embodiments of the invention may be devised without departing from the basic scope thereof, and the scope thereof is determined by the claims that follow.

1. A slit valve assembly, comprising:
a housing having sidewalls and at least one substrate transfer port formed therein, the housing having an interior volume defined by the sidewalls;
a slit valve door disposed within the housing and positionable between an open position clear of the substrate transfer port and a closed position sealing the substrate transfer port;
an actuator coupled to the slit valve door and operable to move the slit valve door between the open and closed positions; and
a flow control circuit having an air supply flow path, a high conductance vent flow path, and a low conductance vent flow path selectively coupled to the actuator.

2. The slit valve assembly of claim 1, wherein the actuator comprises a pneumatic air cylinder.

3. The slit valve assembly of claim 1, further comprising:
at least one sensor configured to detect a position of the slit valve door relative to the open and closed positions.

4. The slit valve assembly of claim 1, wherein the air supply flow path comprises:
a supply of clean, dry air selectively coupled to a first end and a second end of the actuator by a plurality of valves.

5. The slit valve assembly of claim 1, wherein the flow control circuit further comprises:
a switch valve operable to selectively couple the actuator to the high conductance vent flow path or the low conductance vent flow path.

6. The slit valve assembly of claim 1, wherein the flow control circuit further comprises:
a control valve operable to selectively couple a first end and a second end of the actuator to vent exhaust.

7. The slit valve assembly of claim 1, wherein the flow control circuit further comprises:
a first flow control valve fluidly coupled to a first end of the actuator, and
a second flow control valve fluidly coupled to a second end of the actuator, wherein the first and second flow control valves are operable to control a flow rate into the actuator.

8. The slit valve assembly of claim 1, wherein the low conductance vent flow path further comprises:
a flow control valve configured to reduce a flow rate of the low conductance vent flow path to a predetermined flow rate.

9. A method of sealing a chamber coupled to a slit valve assembly, the chamber having a substrate transfer port, comprising:
actuating a slit valve door at a first speed for a first period of time from a first position towards a second position,
detecting a predetermined position of the slit valve door relative to the second position;
actuating the slit valve door at a second speed for a second period of time in response to the detecting, such that the second speed is less than the first speed.

10. The method of claim 9, wherein actuating the slit valve door at the second speed further comprises:
decelerating the slit valve door for the second period of time.

11. The method of claim 10, wherein actuating the slit valve door at the second speed further comprises:
increasing a deceleration rate of the slit valve door during the second period of time.

12. The method of claim 9, wherein actuating at the first speed further comprises:
actuating an air cylinder coupled to the slit valve door by fluidly coupling a supply of air to an inlet of the air cylinder and fluidly coupling an outlet of the air cylinder to a high conductance vent flow path.

13. The method of claim 12, wherein actuating at the second speed further comprises:
fluidly coupling the outlet of the air cylinder to a low conductance vent flow path in response to detecting.

14. The method of claim 13, wherein actuating at the second speed further comprises:
reducing a flow rate of the low conductance vent flow path using a flow control valve.
